(19) United States
(12) Patent Application Publication
(10) Pub. No.: US 2012/0128564 A1
(43) Pub. Date: May 24, 2012

(54) Carbon monoxide reducing system (CMRS)

(75) Inventor: Kentjuan Bowens, Dallas, TX (US)

(73) Assignee: Kentjuan Bowens

(21) Appl. No.: 12/926,502

(22) Filed: Nov. 23, 2010

(51) Int. Cl. B01D 53/62

(52) U.S. Cl. 423/247

(57) ABSTRACT

In accordance to multiple embodiments the CMRS uses calcium carbonate to reduce carbon monoxide and carbon emission. Using three lines and three embodiments with an input and output, all embodiments are enclosed. The lines connect the three embodiments and the source of carbon monoxide. One embodiment is an enclosed tank(s) with burner(s) which heats a liquid mixture of calcium carbonate and additives. The second is framed with filter(s), burner(s), and calcium carbonate inside, which is heated. The three lines connect the two embodiments. As carbon monoxide flows through the embodiments' inside, and out.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

This application relates to reducing carbon monoxide and other carbon emission, specifically to such devices that reduce the harm of carbon monoxide, and reduce carbon emission.

### BACKGROUND

### Prior Art

Cars, trucks, boats, trains, etc. run on fuel for power. This application relates to the fuel emissions of “said” machinery, as well other carbon monoxide producers. Fuel-emission occurs after fuel, and other material is burned. The Carbon Monoxide Reducing System (CMRS), should be placed in a class of its' own. I know of no other system that is used in the reduction of carbon monoxide's harm. No other system includes the luxury of people being in a closed space while carbon monoxide is being produced, and also not be harmed by carbon monoxide gas. Carbon monoxide is deadly and no other device can relate to the reduction of “said” gas. Through, other devices may use certain products to reduce carbon monoxide; none is as systematic as the CMRS, nor do any systems or devices share the process of the CMRS. Carbon monoxide production has several disadvantages.
a) If carbon monoxide filled an enclosed space and an animal is present, the life of the animal may be lost.
b) Carbon monoxide is an air pollutant in which is a disadvantage. This poses many advantages for the CMRS which also acts against the emissions of carbon monoxide.
   One advantage however, of CMRS is that it allows animals to be present in a enclosed space while carbon monoxide is being produced. The advantage of the CMRS offers even more advantages, to the products that help to produce carbon monoxide itself.

### SUMMARY

In accordance to multiple embodiments Carbon Monoxide Reducing System (CMRS), comprises of the following:

Mixing carbon monoxide with calcium carbonate, water, and/or vinegar (liquid) which is brought to a boil to produce steam as carbon monoxide passes through. The steam is then passed through filtered heated calcium carbonate (solid), and then through a process of photosynthesis.

### DRAWING FIGURES

In the flow chart illustration, each figure relates to an embodiment.

FIG. 1—shows the intake of the CMRS.

FIG. 2—shows the steaming embodiment.

FIG. 3—shows the transfer line embodiment.

FIG. 4—shows the filtered heating embodiment.

FIG. 5—shows the transfer line.

FIG. 6—shows the tank embodiment.

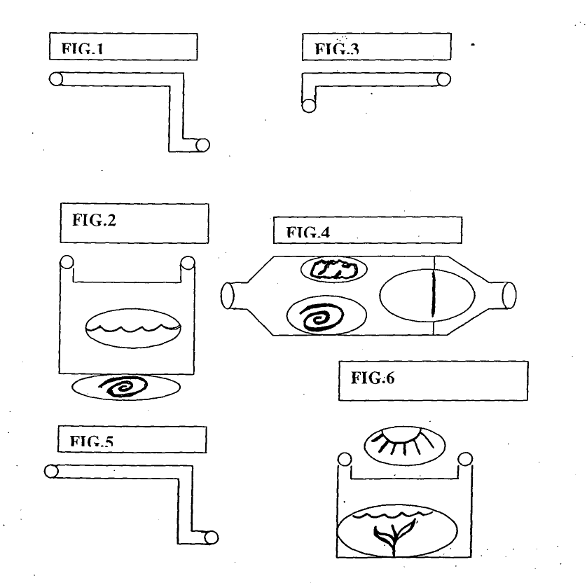

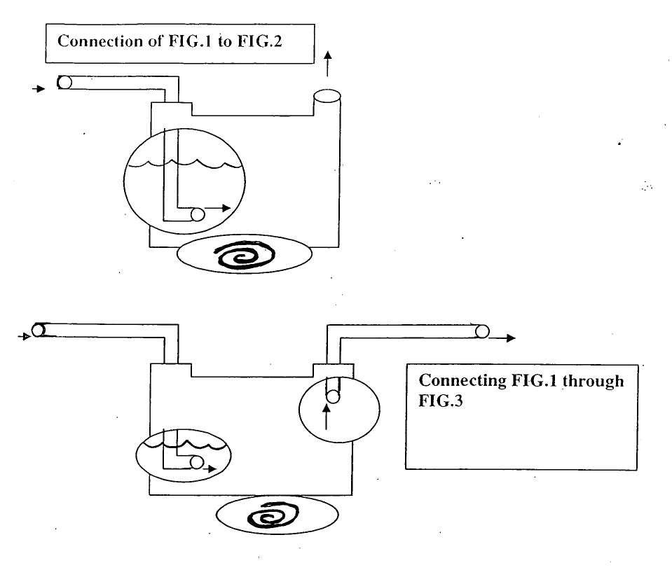

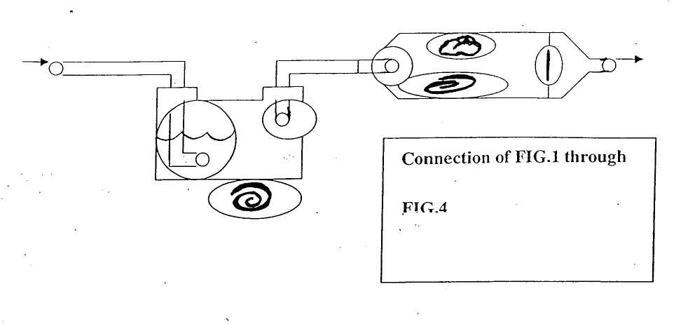

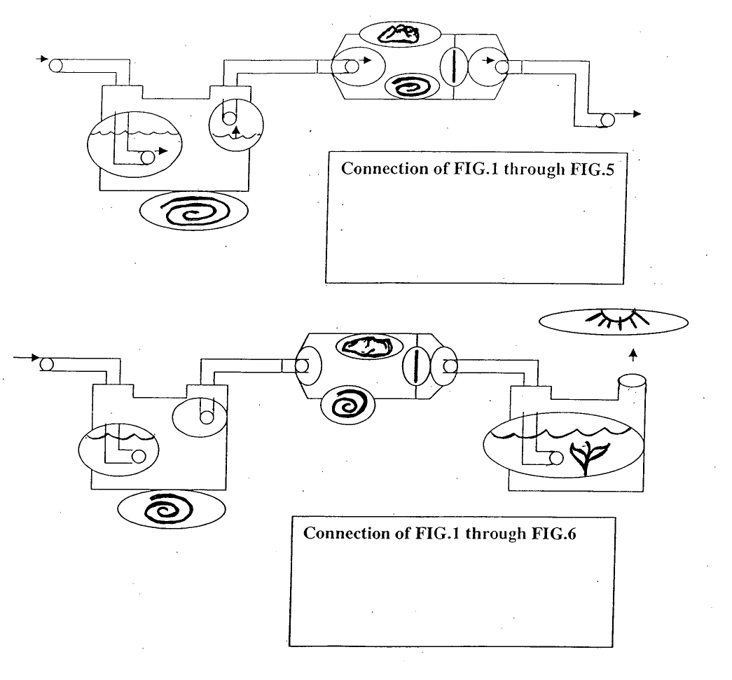

FIG. 1-6 can be composed of many different materials, shapes, sizes, features, etc. A flow and internal view is necessary, indeed because of the variety in design, material, shape, etc.

### DETAILED DESCRIPTION

### Operation

The first embodiment is listed in FIG. 1, the intake which is piping and/or tubing. The intake can also be of different materials, shapes, sizes, features, etc. The intake is use to carry carbon monoxide from the sources' exhaust to FIG. 2. The intake line comes from the carbon monoxide source and is lead to the base of FIG. 2.

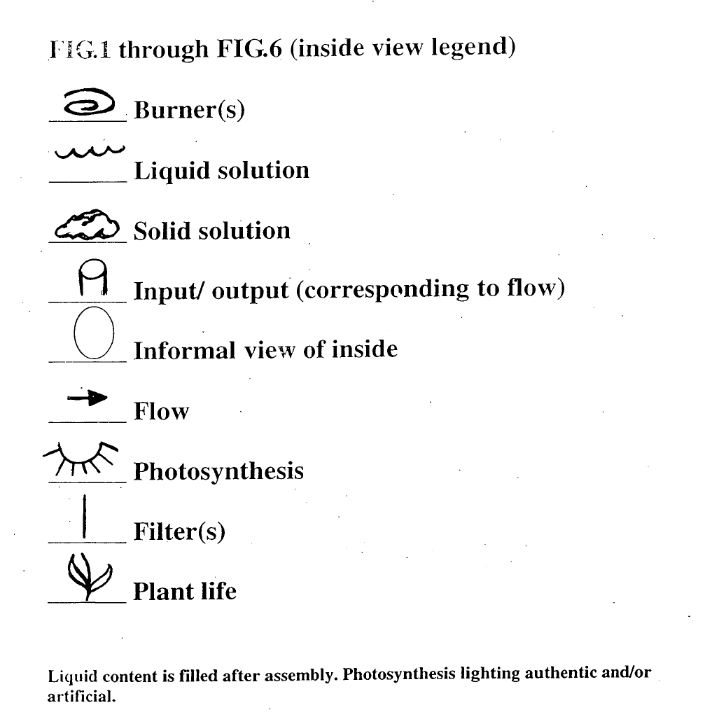

This procedure is done because of the liquid content of FIG. 2 that the carbon monoxide needs to pass through. The intake line is lead toward the bottom of FIG. 2 which comprises of enclosing a tank with burner(s) inside. FIG. 2 is filled with liquefied calcium carbonate, water, and/or vinegar. FIG. 2 has an output located above the liquid content level which is attached to FIG. 3 the transfer line, which is piping and/or tubing to connect FIG. 2 to FIG. 4. FIG. 3 can be comprised of many different materials, shapes, sizes, features, etc. Although, FIG. 1, FIG. 3, and FIG. 5 may be comprised the same they are also used to connect FIG. 2, FIG. 4, and FIG. 6. FIG. 4 is a filtered enclosed embodiment with an input and output, inside the embodiment calcium carbonate is strategically arranged with burner(s). Energy is used to power the embodiments listed as FIG. 2 and FIG. 4. After processing the carbon monoxide gas through FIG. 4 while the device is active an observer will notice a Carbon monoxide detector will not alarm. FIG. 5 is transfer line, which is piping and/or tubing connects FIG. 6. FIG. 6 comprises of tank(s) with input(s) and output(s). FIG. 6 is filled with plant life in the process of photosynthesis. The photosynthesis process can be authentic and artificial by using UV lamps.

FIG. 2, FIG. 4, and FIG. 6 are the most active of the embodiments expressed in this application.

FIG. 1, FIG. 3, and FIG. 5 are piping, lines, and/or tubing used to carry the product from FIG. 2, FIG. 4, and FIG. 6. Although, FIG. 5 and FIG. 6 is not necessary in the reduction of carbon monoxide, they are used for the overall reduction of carbon emission.

FIG. 1 carries carbon monoxide to FIG. 2. FIG. 2 brings calcium carbonate water and/or vinegar (liquid mixture) to a boiling point. This makes steam in which the carbon monoxide is passed through. With the use of FIG. 3 the “said” steam is carried to FIG. 4 where the steam produced by FIG. 2 is filtered through heated calcium carbonate (solid). FIG. 5 is used to carry the filtered gas to FIG. 6. FIG. 6 allows the gas to pass through a process of photosynthesis, and then out the system.

FIG. 1-6 can be manufactured to accommodate the needs of various carbon monoxide producing devices, and can be converted to handle needs.

FIG. 1, FIG. 3, and FIG. 5 uses various materials, shapes, sizes, features, etc. Together they construct the purpose of carrying carbon monoxide from the source into CMRS's FIG. 2, FIG. 4, and FIG. 6.

FIG. 2 is an enclosed boiler with an output and input. The input carries carbon monoxide below the “said” liquid level, in which burner(s) heat the liquid mixture and produces steam. The steam produced from FIG. 2 is released through the output of FIG. 2 which is located above the liquid mixture level.

FIG. 4 is an enclosed framed filtered with an input and output, in which burner(s) heat calcium carbonate (solid) as steamed mixture passes through by exiting the output of FIG. 2. Performance, additional embodiments can be placed on “said” system to boost performance; additives such as pumps, tanks, calculators, mixers, etc.

Magnetic pulse sensor(s) can be inserted onto transportation engine(s) to assist in any air flow restriction, which is mentioned to illustrate how advance the CMRS can be.
The CMRS should not be limited to embodiments.

The CMRS could be manufactured using three lines (piping and/or tubing/embodiment), which are FIG. 1, FIG. 3, and FIG. 6. The three lines connects the three embodiments steam producer(s) (FIG. 2), enclosed frame(s) (FIG. 3), and tank(s) all with input(s) and output(s).

Connect a line from the exhaust of the carbon monoxide source to FIG. 2, in which is an enclosed boiler (steam producer). The enclosed boiler is comprised of tank(s) and burner(s) with two feeds, input and output. The input line of FIG. 2 extends to the base of the embodiment, and the output is placed at the top of the embodiment of FIG. 2.

A line connecting the output of FIG. 2 connects FIG. 2 to FIG. 4.

FIG. 4 which is a framed filtered embodiment contains input(s) and output(s). The input is on one end of the frame and output is on another. Calcium carbonate (solid) is inside the framing of FIG. 4 and is heated with burner(s).

Carbon monoxide passes through FIG. 1-6, as FIGS. 2 and 4 are heated and FIG. 6 produces photosynthesis. Thus reduces carbon monoxide. When placing a carbon monoxide detector at the output of the system viewers may notice the detector does not alarm.

### ADVANTAGES

A number of advantages are clearly evident with the reduction of carbon monoxide, in which the CMRS offers.
The CMRS allows animal life to be present in a closed space which carbon monoxide is being produced. Meaning a person using CMRS can run a motor in a closed garage, which takes the harm from carbon monoxide. Service garage(s) can work on vehicle(s) inside the facility with the vehicle running.
The CMRS can vary in design and usage.
The CMRS can be used as a safety device against fires that produce carbon monoxide.
The CMRS has low cost manufacturing. The CMRS is a process more than design which offers manufacturing flexibility.
   The advantages listed are just to name a few.

### CONCLUSION, RAMIFICATION, AND SCOPE

From the advantages above the reader will see that the CMRS of various embodiments is used for reducing carbon monoxide emissions, and is not limited to other emissions.

In addition to saving lives there are many other advantages the CMRS offers to its user, with the overall reduction of carbon monoxide and carbon emission.

Although, the description contains specifics, such specifics should not be construed as limiting the scope of embodiments or performance. For instance, additional embodiments such as pumps, sensors, tanks, etc., as the addition to embodiments improves performance, and consolidation decreases embodiments. The flow chart illustration is provided merely to give visual aid.

Although, the scope of the embodiments may be specific and primitive, the CMRS should not be limited in design, performance, or structure. Scope should be determined by “said” claims and legal correspondence, rather than mere examples given.

1. A method of using calcium carbonate and additives in a systematic way to reduce carbon monoxide and carbon emission comprises of:
Calcium carbonate is broken into two forms of liquid and solid. The liquid form is composed of additives, such as water, and/or vinegar. The second form is solid.
The “said” forms are placed into two different embodiments. The liquid place into a device that heats enclosed liquids (tank(s), burner(s) with input(s) output(s)). The second form solid should be heated inside framed filtered embodiment.
Three lines (embodiment, piping and/or tubing) connect the three embodiments mentioned. The embodiments mentioned are heated as carbon monoxide passes through. In which, thereafter carbon monoxide emission is reduced.
